(19) United States
(12) Patent Application Publication
(10) Pub. No.: US 2025/0232235 A1
(43) Pub. Date: Jul. 17, 2025

(54) METHODS AND SYSTEMS OF FACILITATING AN EXIT PROCEDURE FROM A CLOUD SERVICE PROVIDER

(71) Applicants: Bence Daniel Hezso, Szeged (HU); Gergely Hezso, Szeged (HU)

(72) Inventors: Bence Daniel Hezso, Szeged (HU); Gergely Hezso, Szeged (HU)

(21) Appl. No.: 18/413,071

(22) Filed: Jan. 16, 2024

(51) Int. Cl. G06Q 10/0631; G06Q 10/0635; H04L 9/40

(52) U.S. Cl. CPC G06Q 10/06313; G06Q 10/0635; H04L 63/10

(57) ABSTRACT

Disclosed herein is a method of facilitating an exit procedure of a project from a cloud service provider. Accordingly, the method may include receiving a client data from a client device, transmitting an access request to a server, receiving a confirmation from the server, generating a data request, transmitting the data request to the server, receiving a server information from the server, analyzing the server information and the project data, identifying a project resource from the plurality of resources associated with the at least one project, analyzing a project resource information based on at least one assessment rule, determining a risk score corresponding to the project resource, analyzing the risk score, generating at least one of an exit strategy and an exit plan based on the risk score, and transmitting at least one of the exit strategy and the exit plan to the client device.

### FIELD OF THE INVENTION

Generally, the present disclosure relates to the field of data processing. More specifically, the present disclosure relates to methods and systems of facilitating an exit procedure of a project from a cloud service provider.

### BACKGROUND OF THE INVENTION

The field of data processing is technologically important to several industries, business organizations, and/or individuals. In particular, the use of data processing is prevalent for facilitating an exit procedure of a project from a cloud service provider.

Currently, there are notable disadvantages to outsourcing infrastructure and platform needs to cloud service providers, including the often-overlooked risks associated with vendor lock-in. This risk is exacerbated by appealing offerings for new clients and aggressive marketing campaigns. The risk is especially high in regulated industries, such as the financial services industry, where specific requirements are imposed by regulators.

Historically, the solutions to these challenges have been either non-existent or inadequate, lacking a systematic approach to address regulatory compliance, risk management, and the complexities of cloud exit strategies. Further, current technologies do not offer a comprehensive and automated solution that not only meets regulatory requirements but also simplifies and streamlines the cloud exit process, distinguishing itself significantly from previous approaches.

In today's competitive environment, companies, and organizations all around the world providing services online services must keep updating their services to meet evolving customer needs and expectations. One of the most effective strategies to stay on par with changing customer needs and expectations is to regularly update internal systems (often legacy ones) with new features or acquire new products from the market. Frequent system updates can be expensive, especially when conducted by in-house teams, as they tend to be inflexible and inefficient. Over recent years, outsourcing has emerged as one of the best approaches for businesses to get easy access to new technologies. The approach is not only cost-effective but also flexible and efficient.

Currently, several cloud-based services allow individuals to rent virtual computers to run their programs and applications. Over the last 15+ years, the cloud-based services market has become more competitive, with providers offering an increasing array of services. The maturity of these services has gained market trust, leading more and more companies to utilize cloud service providers and outsource their infrastructure and platform needs for providing online services. There are multiple advantages of outsourcing the infrastructure and platform needs to cloud service providers. Traditional on-premises infrastructure involves significant capital expenditure for hardware, software, and the physical space to house it. Cloud services typically operate on a pay-as-you-go model, reducing upfront costs and allowing for more predictable operational expenses. Further, outsourcing the infrastructure and platform offers the ability to scale resources up or down based on demand. This flexibility is crucial for handling varying workloads, sudden spikes in traffic, or for businesses that have seasonal fluctuations. Further, cloud service providers handle the maintenance and upgrades of their services. This offloads a significant burden from the client's IT staff, allowing them to focus on more strategic tasks rather than routine maintenance. Further, the cloud service providers often offer the latest technologies, including AI, machine learning, and advanced analytics, which might be too costly or complex for individual companies to implement on their own. Further, the cloud service providers invest heavily in security measures, which can be more robust than what individual companies might afford or manage on their own. Further, the cloud services often have a global network of servers, which helps in delivering content quickly and reliably to users around the world.

Alongside the advantages, there are multiple disadvantages to outsourcing infrastructure and platform needs to the cloud service providers. However, companies and organizations often overlook the risks associated with vendor lock-in, which can be overshadowed by the appealing offerings for new clients and aggressive marketing campaigns of the cloud service providers. The risk associated with vendor lock-in is particularly high for regulated industries, such as the financial services industry, where regulators may impose specific requirements. A cloud exit strategy and plan become crucial when project execution halts due to issues like the vendor's inability to meet required expectations, or when there is a sudden change in system requirements by the company. Clients or companies must assess how far the project has progressed, how potential technological and design changes will be handled, and whether the project scope needs adjustment. Additionally, understanding the financial implications of these changes is essential. Currently, this information is primarily accessible through a manual cloud exit assessment of the project. Further, manual cloud exit assessment is a relatively new topic in the market, as there are neither formal procedures nor established metrics for determining the expected output of the assessment or for creating an exit strategy and plan for the client. Furthermore, this process is not only time-consuming but also expensive. For complex projects, external consultants or in-house auditors may need weeks or even months to complete an assessment and develop an exit strategy and plan. In cases involving special technologies, hiring specialists becomes necessary, further increasing the costs. Additionally, manual processes are prone to errors, such as omissions. Further, manually conducted cloud exit assessments may not effectively track changes in the outsourced infrastructure and platform elements. Keeping these assessments regularly updated can be an energy-intensive task.

Therefore, there is a need for improved methods and systems of facilitating an exit procedure of a project from a cloud service provider that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating an exit procedure of a project from a cloud service provider, in accordance with some embodiments. Accordingly, the method may include receiving, using a communication device, at least one client data from at least one client device associated with a client. Further, the at least one client data may include a client credential associated with the client and at least one project data associated with at least one project. Further, the method may include transmitting, using the communication device, an access request to a server associated with a cloud service provider. Further, the access request may be based on the client credential. Further, the method may include receiving, using the communication device, a confirmation corresponding to the access request from the server. Further, the method may include generating, using a processing device, a data request based on the confirmation. Further, the method may include transmitting, using the communication device, the data request to the server. Further, the method may include receiving, using the communication device, a server information from the server based on the data request. Further, the server information may include a plurality of resource information associated with a plurality of resources comprised in the server. Further, the plurality of resource information characterizes the plurality of resources. Further, the method may include analyzing, using the processing device, the server information and the at least one project data. Further, the method may include identifying, using the processing device, at least one project resource from the plurality of resources associated with the at least one project based on the analyzing of the server information and the at least one project data. Further, the method may include analyzing, using the processing device, at least one project resource information associated with the at least one project resource based on at least one assessment rule. Further, the server information may include the at least one project resource information. Further, the method may include determining, using the processing device, at least one risk score corresponding to the at least one project resource based on the analyzing of the at least one project resource information. Further, the method may include analyzing, using the processing device, the at least one risk score. Further, the method may include generating, using the processing device, at least one of an exit strategy and an exit plan based on the analyzing of the at least one risk score. Further, the method may include transmitting, using the communication device, at least one of the exit strategy and the exit plan to the at least one client device.

Further disclosed herein is a system of facilitating an exit procedure of a project from a cloud service provider, in accordance with some embodiments. Accordingly, the system may include a communication device configured for receiving at least one client data from at least one client device associated with a client. Further, the at least one client data may include a client credential associated with the client and at least one project data associated with at least one project. Further, the communication device may be configured for transmitting an access request to a server associated with a cloud service provider. Further, the access request may be based on the client credential. Further, the communication device may be configured for receiving a confirmation corresponding to the access request from the server. Further, the communication device may be configured for transmitting a data request to the server. Further, the communication device may be configured for receiving a server information from the server based on the data request. Further, the server information may include a plurality of resource information associated with a plurality of resources comprised in the server. Further, the plurality of resource information characterizes the plurality of resources. Further, the communication device may be configured for transmitting at least one of an exit strategy and an exit plan to the at least one client device. Further, the system may include a processing device communicatively coupled with the communication device. Further, the processing device may be configured for generating the data request based on the confirmation. Further, the processing device may be configured for analyzing the server information and the at least one project data. Further, the processing device may be configured for identifying at least one project resource from the plurality of resources associated with the at least one project based on the analyzing of the server information and the at least one project data. Further, the at least one project resource may be configured for implementing the at least one project. Further, the processing device may be configured for analyzing at least one project resource information associated with the at least one project resource based on at least one assessment rule. Further, the server information may include the at least one project resource information. Further, the processing device may be configured for determining at least one risk score corresponding to the at least one project resource based on the analyzing of the at least one project resource information. Further, the at least one risk score represents a severity of a risk associated with the at least one project resource. Further, the processing device may be configured for analyzing the at least one risk score. Further, the processing device may be configured for generating at least one of the exit strategy and the exit plan based on the analyzing of the at least one risk score.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a flow chart of a method 100 of facilitating an exit procedure of a project from a cloud service provider, in accordance with some embodiments.

FIG. 2 is a flow chart of a method 200 of facilitating the exit procedure of the project from the cloud service provider, in accordance with some embodiments.

FIG. 3 is a flow chart of a method 300 of facilitating the exit procedure of the project from the cloud service provider, in accordance with some embodiments.

FIG. 4 is a flow chart of a method 400 of facilitating the exit procedure of the project from the cloud service provider, in accordance with some embodiments.

FIG. 5 is a flow chart of a method 500 of facilitating the exit procedure of the project from the cloud service provider, in accordance with some embodiments.

FIG. 6 is a flow chart of a method 600 of facilitating the exit procedure of the project from the cloud service provider, in accordance with some embodiments.

FIG. 7 is a flow chart of a method 700 of facilitating the exit procedure of the project from the cloud service provider, in accordance with some embodiments.

FIG. 8 is a flow chart of a method 800 of facilitating the exit procedure of the project from the cloud service provider, in accordance with some embodiments.

FIG. 9 is a block diagram of a system 900 of facilitating an exit procedure of a project from a cloud service provider, in accordance with some embodiments.

FIG. 10 is a block diagram of the system 900 of facilitating the exit procedure of the project from the cloud service provider, in accordance with some embodiments.

FIG. 11 is a block diagram of the system 900 of facilitating the exit procedure of the project from the cloud service provider, in accordance with some embodiments.

FIG. 12 is a flow chart of a method 1200 of facilitating an exit procedure of a project from a cloud service provider, in accordance with some embodiments.

FIG. 13 is an illustration of an online platform consistent with various embodiments of the present disclosure.

FIG. 14 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems of facilitating an exit procedure of a project from a cloud service provider, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure describes methods and systems of facilitating an exit procedure of a project from a cloud service provider. Further, the disclosed system may be associated with a software solution to automate and streamline the cloud exit assessment process.

Further, the disclosed system may receive inputs from a client. Further, the disclosed system may be configured for discovery assessment based on the following inputs:

Phase 1: In the initial phase, the client may create a project including the following details:
Project Name
Project Description
Project Type
COTS for Internal Use
Custom Developed Applications for Internal Use
COTS for External Use
Custom Developed Applications for External Use
Other
Exit Strategy*
Repatriation to On-Premises
Hybrid Cloud Adoption
Migration to Alternate Cloud
Sync Interval*
Weekly
Monthly
Custom

Further, two main inputs from phase 1 of the discovery assessment are the ‘Exit Strategy’ and ‘Sync Interval,’ as the assessment is scheduled based on a selected sync interval, and the risk assessment (part of the cloud exit assessment) is conducted based on a selected exit strategy value.

Further, in phase 2 of the discovery assessment, the client may select a cloud service provider for the project. Based on a selected cloud service provider, the assessment scope must be defined, and credentials must be set:
In the case of Microsoft™ Azure:
The client may create a service principal and generate a client secret with the appropriate role assignment in the Microsoft Entra ID (previous name: Azure Active Directory),
The client may test the connection with the credentials on the disclosed platform and define the assessment scope, which may be a Resource Group or Subscription,
The credentials are only stored encrypted in the secret management store.
In the case of Amazon™ Web Services:
The client must create an access key and a secret key with the appropriate policy in the Identity and Access Management,
The client must test the connection with the credentials on our platform and define the assessment scope, which can be the AWS account region,
The credentials are only stored encrypted in the secret management store.

The credentials associated with the project may be decrypted only by an assessment handler associated with the disclosed system to discover the cloud-based resources used within the defined scope. It is the client's responsibility to use recommended role assignments or policies to avoid privilege creep or failed assessment.

Further, in a phase 3 of the discovery assessment, if the client operates in the Financial Services sector and is active in the European Union market, the client may set the following project details necessary to assess the project in terms of the European Banking Federation's rating grid:
Control Framework
Private setup
Hybrid, within the network perimeter all accesses are controlled by an institution
Hybrid, within network perimeter accesses are partially controlled
Hybrid, with partial public setup outside of network perimeter control
Public setup
Regulatory Context
Only a European Union (EU) home country regulation is applicable
Only EU country regulation is applicable (but of more than one Member State)
Mainly EU regulation is applicable but also “recognized” third countries' regulations are involved
Mainly non-EU regulation is applicable but from “recognized” third countries
Regulation of “non-recognized” third countries is applicable
Data Criticality
Public data
Internal “low-relevance” non-identifiable data
Internal relevant non-identifiable data
Internal relevant identifiable data
Internal relevant identifiable sensitive data
Function Criticality
Replaceable and not relevant part of core processes
Replaceable but necessary for internal processes
Necessary for external processing
Part of core process, necessary for full function, recovery target in disaster recovery up to 48 h
Unavoidable part of the core process

Further, the European Banking Federation's rating grid includes a fifth input (“layer”); however, the value of the fifth input layer is calculated during the cloud exit assessment because the fifth input is based on the cloud-based resources and service models used.

Further, the disclosed system may be configured for performing the assessment procedure of the project. Further, a phase 0 of the assessment procedure may include a scheduler function that orchestrates the scheduling of a ‘Run Assessment’ function in the disclosed system. This scheduler operates through a synergy of a task queue system and a message broker. It functions by periodically activating a command that reviews all projects, examining their last synchronization time and interval, without specifying the use of any particular technology such as CronJobs. When a project is identified as due for an assessment, this command places a task in the task queue via the message broker. These tasks are subsequently processed asynchronously by workers, ensuring precise and timely execution of each project's assessment in line with its scheduled timeline.

Further, a phase I of the assessment procedure may include a run assessment with a primary role to fetch a next assessment job from the task queue. Further, the run assessment determines the appropriate function to use, based on the specific cloud service provider involved, to carry out the ensuing phases of assessment.

Further, a phase II of the assessment procedure may include a discovery assessment. Further, in the first step, the ‘Discovery’ function decrypts the credentials associated with the project and tests the connection to a cloud service provider's (CSP) application programming interface (API):

If the connection is unsuccessful, either because the credentials are no longer valid or due to a connection error with the CSP interface, the function stops and updates the project status to ‘Sync failed’.

If the connection is successful, the function continues to the next step and updates the project status to ‘Sync in progress’.

In the subsequent step, the ‘Discovery’ function iterates through the resources used within the defined scope and collects data to build a resource inventory, which is then associated with the project. (During communication with the API, the function uses a predefined list of strings that map the used resources to the cloud service provider's services.)

The next step is optional, as it is only required if the project falls under European regulatory requirements. The predefined list of strings mapping includes a ‘layer’ field, which assigns a value from 1 to 5 to all cloud-based resources. Based on the resources in the Resource Inventory, the function calculates the Layer value for the project.

In the final step, the function updates the project status to ‘Successful sync’ and updates a last_sync value to a current timestamp.

Further, a Phase III of the assessment procedure may include a risk assessment function based on the data collected during the ‘Discovery’ phase. Further, the risk assessment fetches all resources from the Resource Inventory associated with the project and examines them according to the following rule sets:
Rule set #1:
Name: The resource has fewer than three but more than one alternative technology available in our platform's ‘Alternative Technology’ dataset.
Severity: medium
Rule set #2:
Name: The resource has no alternative technology available in our platform's ‘Alternative Technology’ dataset.
Severity: high
Rule set #3:
Name: The resource has fewer than three but more than one alternative technology that offers Enterprise Support available in our platform's ‘Alternative Technology’ dataset.
Severity: low
Rule set #4:
Name: The resource has no alternative technology that offers Enterprise Support available in our platform's ‘Alternative Technology’ dataset.
Severity: medium
Rule set #5:
Name: The Resource Inventory includes more than 30 resources.
Severity: high
Rule set #6:
Name: The Resource Inventory includes more than 15 but fewer than or equal to 30 resources.
Severity: medium
Rule set #7:
Name: The Resource Inventory includes more than 15 different types of resources.
Severity: high
Rule set #8:
Name: The Resource Inventory includes more than 10 but fewer than or equal to 15 different types of resources.
Severity: medium

The baseline rule sets can be continuously fine-tuned based on market best practices and client feedback.

After the risk assessment function has finished, the disclosed system may be configured to store the risks associated with the project in the Risk Inventory.

The results of the cloud exit assessment are accessible on the platform, and they can also be downloaded as a comprehensive executive summary, an exit strategy, or an exit plan.

Further, the disclosed system may provide a platform that provides clients with a summarized view based on the project's assessment results. This includes an overview of the project, a list of resources in the resource inventory, a compilation of identified risks in the risk inventory, and a selection of alternative technologies tailored to the project's exit strategy and the resources cataloged in the resource inventory.

If the client operates in the Financial Services sector and is active in the European Union market, the disclosed platform displays a radar chart with five angles representing project values based on the European Banking Federation's rating grid. Additionally, the disclosed system features a Radar Chart with three angles using our self-developed and maintained ‘Escape’ rating grid.

Further, the disclosed system may be configured to provide an executive summary comprising a PDF and has the following structure: Cover, Project Overview, Service Models & Cost Overview, Resource Inventory, Risk Assessment, Alternative Technologies, Compliance and Regulatory Considerations, and Glossary. Further, a length of the executive summary is between 5-10 pages.

Further, the disclosed system may be configured to provide an exit strategy that may be a file such as a PDF and has the following structure: Cover, Project Overview, Service Models, Cost Analysis, Resource Inventory, Risk Assessment, Alternative Technologies, Compliance & Regulatory Considerations, Timeline and Milestones, Glossary.

The length of the exit strategy document is between 10-30 pages. The initial structure of the exit strategy document may be changed in accordance with industry best practices and regulatory changes.

Further, the disclosed system may be configured to provide an exit plan that may be a PDF document and has the following structure: Cover, Project Overview, Service Models, Cost Analysis, Resource Inventory, Risk Assessment, Alternative Technologies, Compliance & Regulatory Considerations, Transition Plan, Testing and Validation, Resource Allocation, and Glossary.

Further, the disclosed system may be configured for generating an exit strategy to understand the exact state of the project and the viable options moving forward.

Further, the disclosed system may be configured to facilitate the transition from a cloud service provider to on-premises solutions or another cloud service provider during the cloud exit process.

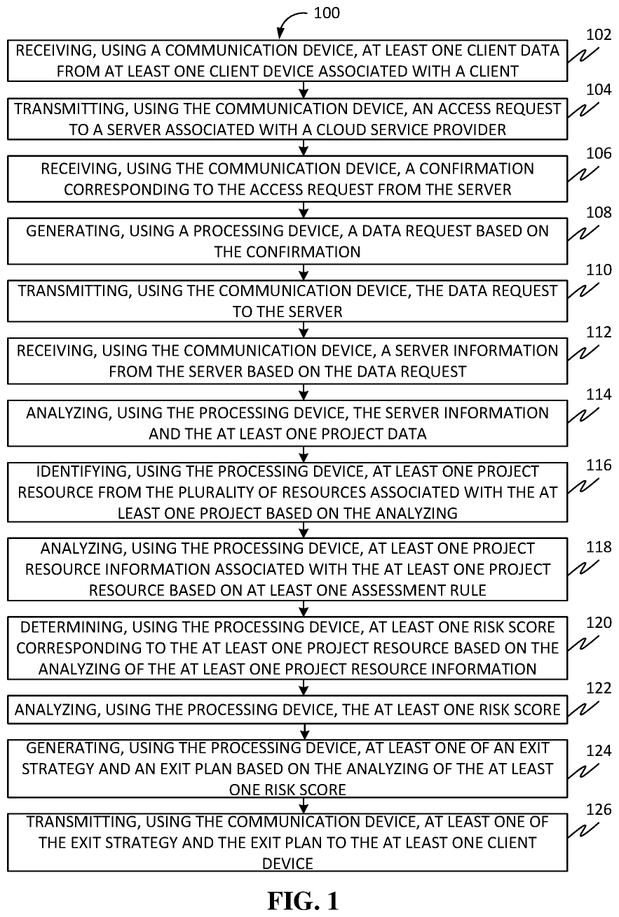

FIG. 1 is a flow chart of a method 100 of facilitating an exit procedure of a project from a cloud service provider, in accordance with some embodiments. Accordingly, at 102, the method 100 may include receiving, using a communication device (such as a communication device 902), at least one client data from at least one client device (such as at least one client device 1002) associated with a client. Further, the at least one client data may include a client credential associated with the client and at least one project data associated with at least one project. Further, the client credential may include a client name, an address, an email address, a password, an identification number, etc. Further, the at least one client device may include a smartphone, a tablet, a laptop, a mobile, and so on. Further, the at least one project data may include a project name, a project description, and a project type. Further, the at least one project data describes the at least one project. Further, the at least one project may include at least one software application.

Further, at 104, the method 100 may include transmitting, using the communication device, an access request to a server (such as a server 1004) associated with a cloud service provider. Further, the access request may be based on the client credential.

Further, at 106, the method 100 may include receiving, using the communication device, a confirmation corresponding to the access request from the server. Further, the confirmation may include a positive response from the server indicating granting of access to a cloud platform provided by the cloud service provider. Further, the cloud platform hosts the at least one project.

Further, at 108, the method 100 may include generating, using a processing device (such as a processing device 904), a data request based on the confirmation. Further, at least one available metadata associated with the server may be requested using the data request. Further, the at least one metadata may include data associated with used resources or services' names, types, kinds, versions, locations, costs, etc.

Further, at 110, the method 100 may include transmitting, using the communication device, the data request to the server.

Further, at 112, the method 100 may include receiving, using the communication device, a server information from the server based on the data request. Further, the server may be associated with a platform. Further, the server information may include a plurality of resource information associated with a plurality of resources comprised in the server. Further, the server may provide the plurality of resources. Further, the plurality of resource information characterizes the plurality of resources. Further, the plurality of resources may include physical resources such as processor resources, network interface resources, memory resources bus resources, input/output (I/O) resources, etc. Further, the plurality of resources may include logical resources such as compute power, network throughput, memory (RAM) size, storage size, etc.

Further, at 114, the method 100 may include analyzing, using the processing device, the server information and the at least one project data.

Further, at 116, the method 100 may include identifying, using the processing device, at least one project resource from the plurality of resources associated with the at least one project based on the analyzing of the server information and the at least one project data. Further, the at least one project resource may be configured for implementing the at least one project.

Further, at 118, the method 100 may include analyzing, using the processing device, at least one project resource information associated with the at least one project resource based on at least one assessment rule. Further, the server information may include the at least one project resource information. Further, the at least one assessment rule may include a set of rules.

Further, at 120, the method 100 may include determining, using the processing device, at least one risk score corresponding to the at least one project resource based on the analyzing of the at least one project resource information. Further, the at least one risk score represents a severity of a risk associated with the at least one project resource. Further, the at least one risk score may range between a minimum risk score to a maximum risk score.

Further, at 122, the method 100 may include analyzing, using the processing device, the at least one risk score.

Further, at 124, the method 100 may include generating, using the processing device, at least one of an exit strategy and an exit plan based on the analyzing of the at least one risk score. Further, at least one of the exit strategy and the exit plan describes the at least one risk associated with the at least one project resource. Further, at least one of the exit strategy and the exit plan may describe the at least one risk during migration of the at least one project to a destination platform due to compliance, cost, performance, and other factors. Further, at least one of the exit strategy and the exit plan may include an executive summary of the at least one project. Further, the executive summary may indicate a progress status of the at least one project. Further, at least one of the exit strategy and the exit plan may provide a flow of a process that may guide the client to migrate the at least one project to the destination platform. Further, the destination platform may include an alternate cloud platform, an on-premises data center, or a combination of both.

Further, at 126, the method 100 may include transmitting, using the communication device, at least one of the exit strategy and the exit plan to the at least one client device. Further, at least one of the exit strategy and the exit plan may include an overview of the at least one project, a list of resources, and a compilation of identified risks.

Further, in some embodiments, the at least one project data may include a sync interval data for scheduling the assessment of the cloud platform. Further, the transmitting of the data request may be based on the sync interval data. Further, the sync interval data may include a time interval after which an assessment of the cloud platform is to be performed. Further, in some embodiments, the time interval may be set by the client. Further, in an instance, the time interval may be an hour, a day, a week, a month, etc.

Further, in some embodiments, the at least one project data may include an exit strategy value for performing a risk assessment of the at least one project resource. Further, the analyzing of the at least one project resource information may be based on the exit strategy value.

Further, in some embodiments, the method 100 may include retrieving, using a storage device (such as a storage device 1104), a plurality of sets of scope assessing elements and a plurality of assessing schemes. Further, the analyzing of the server information and the at least one project data may include identifying at least one set of scope assessing elements from the plurality of sets of scope assessing elements and at least one assessment scheme corresponding to the at least one set of scope assessing elements associated with an assessment scope of the at least one project based on the at least one project data. Further, the plurality of assessment schemes may include the at least one assessment scheme. Further, the at least one project data may include at least one characteristic of the at least one project and at least one indication of the cloud platform associated with the at least one project. Further, the at least one characteristic of the at least one project may include usage, architecture, dependency, security, compliance, lifecycle, goals, type, etc. Further, the at least one set of scope assessing elements and the at least one assessment scheme identified for the assessment scope may be specific to the at least one project and the cloud platform associated with the at least one project. Further, the at least one project may be assessed based on the assessment scope of the at least one project. Further, the at least one assessment scheme may include computer executable code for evaluating the at least one project based on the at least one set of scope assessing elements identified for the assessment scope. Further, the at least one set of scope assessing elements may include components, metrics, considerations, etc., for assessing the at least one project under the assessment scope. Further, the at least one set of scope assessing elements corresponds to at least one cloud service provided by a cloud platform. Further, the at least one cloud service may include Infrastructure as a Service (IaaS), Platform as a Service (PaaS), Database as a Service (DBaaS), Compliance and Security Services, Hybrid and Multi-Cloud Environments, etc. Further, the components include virtual machines, storage, networking, etc., the metrics include CPU utilization, Memory usage, Disk I/O performance, Network bandwidth, Latency, etc., and the considerations include virtual machine (VM) sizing and configurations, Load balancing strategies, Network security and isolation, Disk storage performance, etc. for the Infrastructure as a Service (IaaS). Further, the components include On-premises infrastructure, Cloud resources from different providers, Interconnectivity services, etc., the metrics include Inter-cloud data transfer rates, Hybrid workload distribution, Consistency in resource configurations, Latency between on-premises and cloud resources, etc., and the considerations include Data transfer costs, Interoperability between cloud providers, Consistency in security policies, Failover and disaster recovery strategies, etc. for the Hybrid and Multi-Cloud Environments. Further, the analyzing of the server information and the at least one project data may include implementing the at least one assessment scheme utilizing the at least one set of scope assessing elements on the server information based on the identifying of the at least one set of scope assessing elements. Further, the identifying of the at least one project resource may be based on the implementing of the at least one assessment scheme. Further, the at least one resource information may be determined based on the identifying of the at least one project resource and the implementing of the at least one assessment scheme. Further, the implementing may include executing the at least one assessment scheme utilizing the at least one set of scope assessing elements.

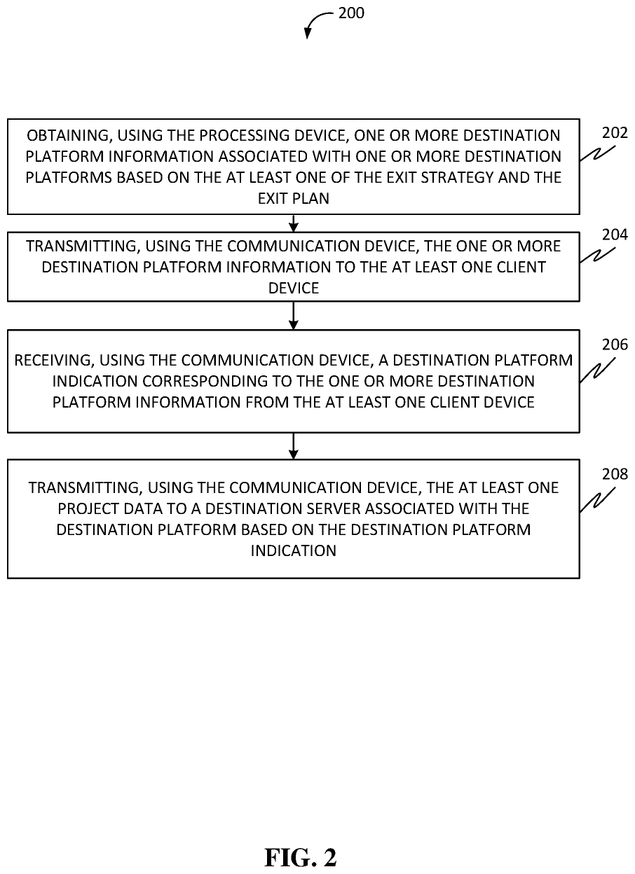

FIG. 2 is a flow chart of a method 200 of facilitating an exit procedure of a project from a cloud service provider, in accordance with some embodiments. Accordingly, at 202, the method 200 may include obtaining, using the processing device, one or more destination platform information associated with one or more destination platforms based on at least one of the exit strategy and the exit plan. Further, the one or more destination platform information may include information associated with resources of the one or more destination platforms. Further, the resources of the one or more destination platforms may include processor resources, network interface resources, memory resources bus resources, input/output (I/O) resources, etc.

Further, at 204, the method 200 may include transmitting, using the communication device, the one or more destination platform information to the at least one client device.

Further, at 206, the method 200 may include receiving, using the communication device, a destination platform indication corresponding to the one or more destination platforms from the at least one client device. Further, the destination platform indication may be associated with the destination platform.

Further, at 208, the method 200 may include transmitting, using the communication device, the at least one project data to a destination server (such as a destination server 1102) associated with the destination platform based on the destination platform indication. Further, the at least one project may be created on the destination server with a defined scope and one or more credentials for a service provider associated with the destination server may be set based on the at least one project data.

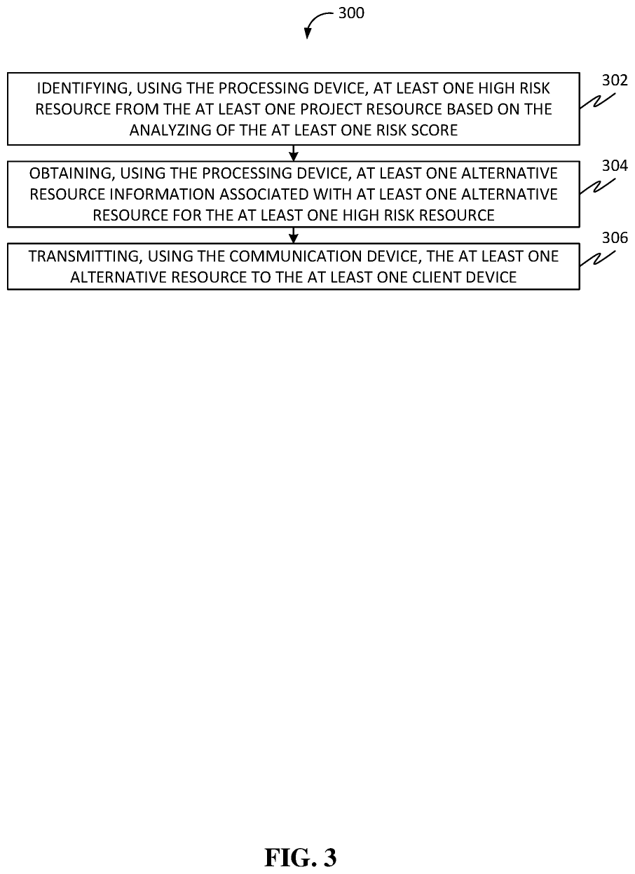

FIG. 3 is a flow chart of a method 300 of facilitating the exit procedure of the project from the cloud service provider, in accordance with some embodiments. Accordingly, at 302, the method 300 may include identifying, using the processing device, at least one high risk resource from the at least one project resource based on the analyzing of the at least one risk score. Further, the at least one high risk resource may be characterized by a high risk score. Further, the high risk score may be a score greater than a threshold risk score. Further, the threshold risk score lies between the minimum risk score and the maximum risk score.

Further, at 304, the method 300 may include obtaining, using the processing device, at least one alternative resource information associated with at least one alternative resource for the at least one high risk resource. Further, the at least one alternative resource information may include a selection of alternative technologies tailored to at least one of the exit strategy and the exit plan.

Further, at 306, the method 300 may include transmitting, using the communication device, the at least one alternative resource information to the at least one client device.

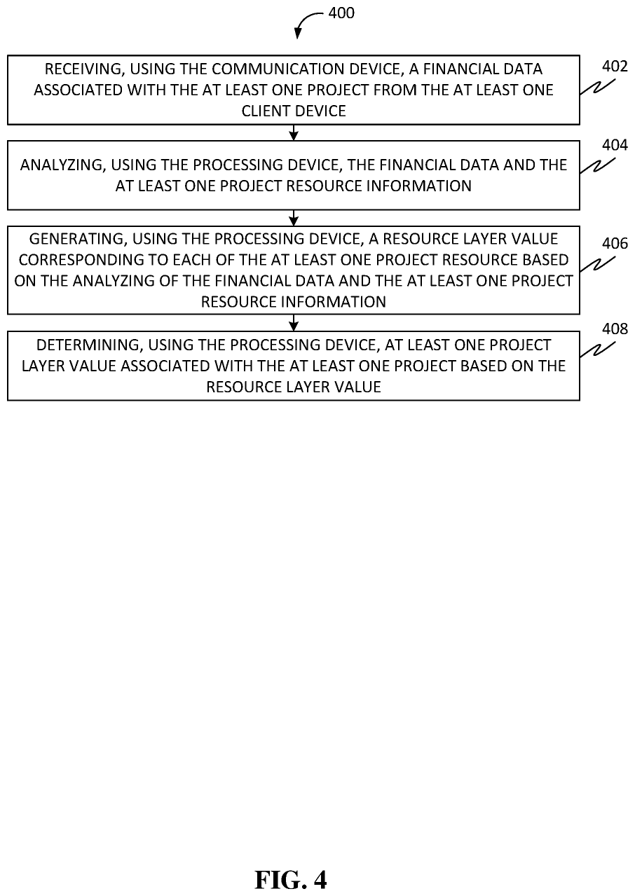

FIG. 4 is a flow chart of a method 400 of facilitating the exit procedure of the project from the cloud service provider, in accordance with some embodiments. Accordingly, the at least one project may include at least one financial project associated with a financial sector in a region. Further, the region may be a European region (such as a state in the European Union). Further, at 402, the method 400 may include receiving, using the communication device, a financial data associated with the at least one project from the at least one client device. Further, the financial data corresponds to the region. Further, in some embodiments, a first financial data associated with a first region may be different from a second financial data associated with a second region. Further, the financial data may include a control framework information, a regulatory context information, a data criticality information, a function criticality information, etc. Further, the financial data may facilitate assessing the at least one project based on a rating grid of a banking federation associated with the region. Further, at 404, the method 400 may include analyzing, using the processing device, the financial data and the at least one project resource information. Further, at 406, the method 400 may include generating, using the processing device, a resource layer value corresponding to each of the at least one project resource based on the analyzing of the financial data and the at least one project resource information. Further, the resource layer value corresponds to alignment of the at least one project resource with a resource requirement of the at least one project. Further, at 408, the method 400 may include determining, using the processing device, at least one project layer value associated with the at least one project based on the resource layer value. Further, the generating of at least one of the exit strategy and the exit plan may be based on the at least one project layer value. Further, the at least one project layer value may correspond to a usage of at least one resource of the platform.

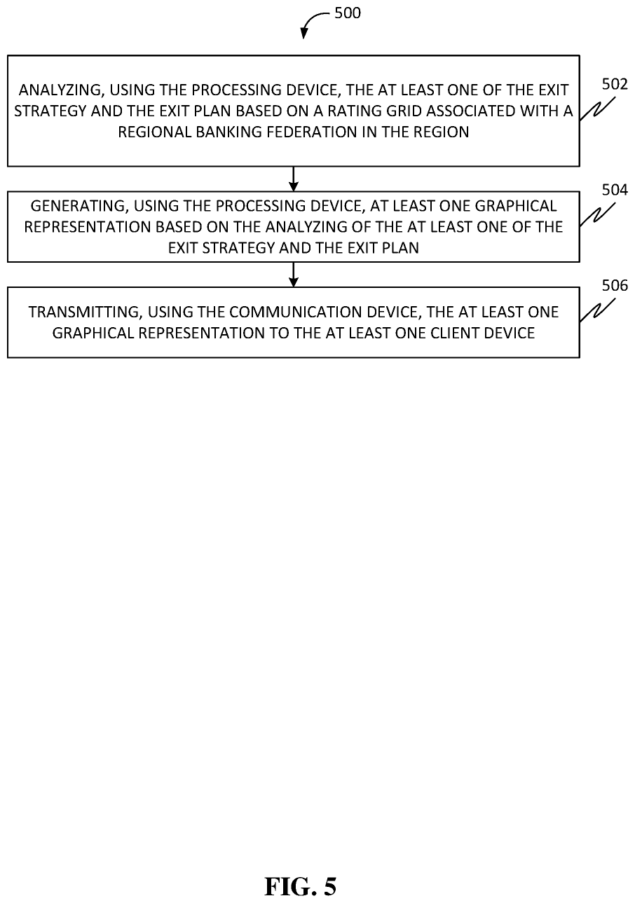

FIG. 5 is a flow chart of a method 500 of facilitating the exit procedure of the project from the cloud service provider, in accordance with some embodiments. Further, at 502, the method 500 may include analyzing, using the processing device, at least one of the exit strategy and the exit plan based on a rating grid associated with a regional banking federation in the region. Further, at 504, the method 500 may include generating, using the processing device, at least one graphical representation based on the analyzing of at least one of the exit strategy and the exit plan. Further, the at least one graphical representation may include a radar chart with five angles representing project values based on a rating grid of the European Banking Federation. Further, the at least one graphical representation represents the at least one project value. Further, at 506, the method 500 may include transmitting, using the communication device, the at least one graphical representation to the at least one client device.

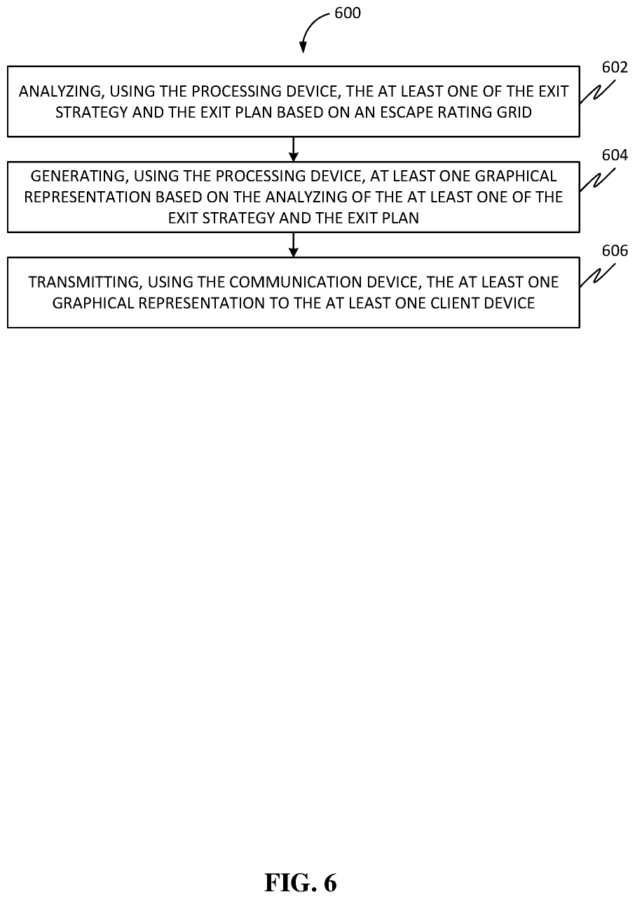

FIG. 6 is a flow chart of a method 600 of facilitating the exit procedure of the project from the cloud service provider, in accordance with some embodiments. Further, at 602, the method 600 may include analyzing, using the processing device, at least one of the exit strategy and the exit plan based on an escape rating grid. Further, at 604, the method 600 may include generating, using the processing device, at least one graphical representation based on the analyzing of at least one of the exit strategy and the exit plan. Further, the at least one graphical representation represents the at least one project value. Further, at 606, the method 600 may include transmitting, using the communication device, the at least one graphical representation to the at least one client device. Further, the at least one graphical representation may include a radar chart with three angles.

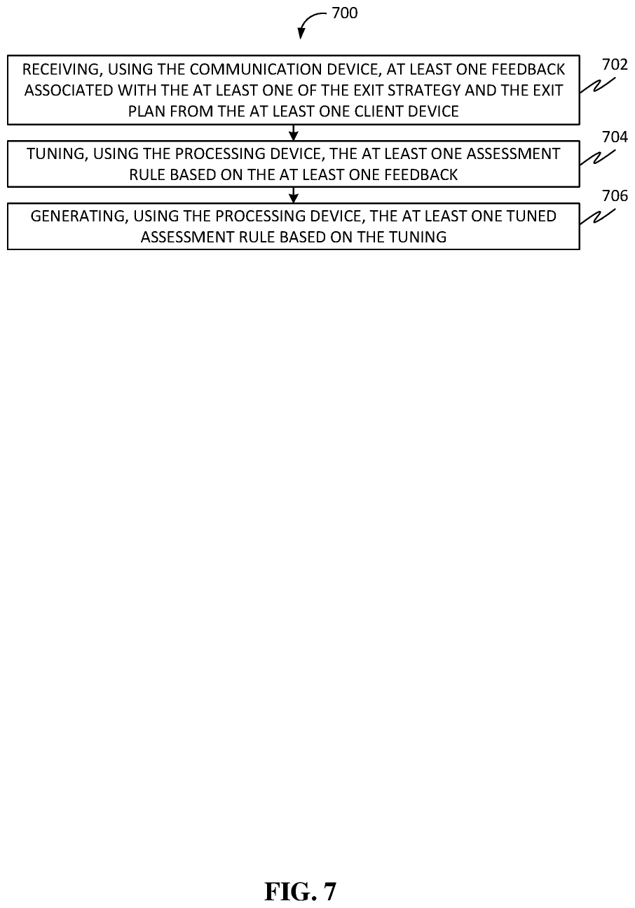

FIG. 7 is a flow chart of a method 700 of facilitating the exit procedure of the project from the cloud service provider, in accordance with some embodiments. Further, at 702, the method 700 may include receiving, using the communication device, at least one feedback associated with at least one of the exit strategy and the exit plan from the at least one client device. Further, the at least one feedback may include an input representing amendment and/or suggestion from the client for at least one of the exit strategy and the exit plan. Further, in some embodiments, the at least one feedback may include at least one preference for the at least one project resource. Further, the at least one preference may indicate a significance or cruciality of the at least one project resource. Further, at 704, the method 700 may include tuning, using the processing device, the at least one assessment rule based on the at least one feedback. Further, at 706, the method 700 may include generating, using the processing device, at least one tuned assessment rule based on the tuning. Further, the analyzing of the at least one project resource information may be based on the at least one tuned assessment rule.

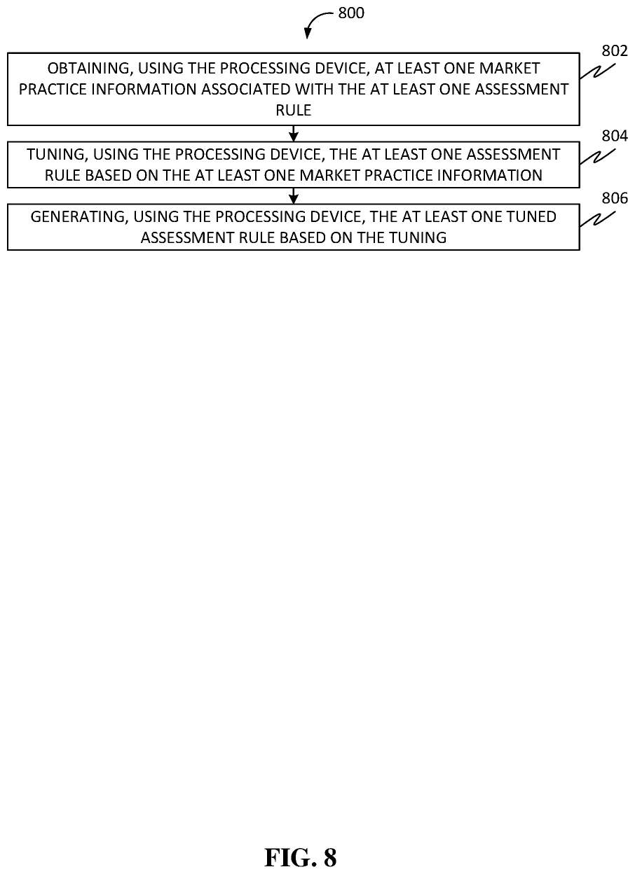

FIG. 8 is a flow chart of a method 800 of facilitating the exit procedure of the project from the cloud service provider, in accordance with some embodiments. Further, at 802, the method 800 may include obtaining, using the processing device, at least one market practice information associated with the at least one assessment rule. Further, the at least one market practice information represents one or more characteristics of at least one cloud service provided by at least one second cloud service provider. Further, the one or more characteristics of the at least one cloud service provided by at least one second cloud service provider may include specifications associated with at least one resource provided by the at least one second cloud service. Further, the specifications may include hardware specifications and software specifications. Further, at 804, the method 800 may include tuning, using the processing device, the at least one assessment rule based on the at least one market practice information. Further, at 806, the method 800 may include generating, using the processing device, at least one tuned assessment rule based on the tuning. Further, the analyzing of the at least one project resource information may be based on the at least one tuned assessment rule.

Further, in some embodiments, at least one of the exit strategy and the exit plan may include a cost analysis information, a risk assessment information, and a compliance and regulatory consideration information.

Further, in some embodiments, the obtaining of the at least one market practice information may include obtaining the at least one market practice information in real time.

Further, in some embodiments, the method 800 may include retrieving, using the storage device, at least one machine learning model representing at least one information associated with characteristics of conditional elements in the at least one assessment rule. Further, the at least one machine learning model may include a recognition model. Further, the method 800 may include extracting, using the processing device, at least one characteristic from the at least one market practice information associated with the at least one assessment rule for forming at least one feature vector. Further, the at least one market practice information corresponds to at least one regulation, at least one law, at least one ruling, etc., passed recently or to be passed in the future for assessing the risk associated with the at least one project. Further, the at least one characteristic may include at least one information of a dependency condition, a triggering mechanism, a Boolean logic, a If-Then logic, a hierarchy, a priority, a threshold, a state, etc., associated with the conditional elements in the at least one assessment rule. Further, the at least one information corresponds to a classification data related to the at least one market practice information. Further, the method 800 may include identifying and tracking, using the processing device, a relationship between two or more conditional elements as the classification data in the at least one market practice information by processing the at least one feature vector using the at least one machine learning model. Further, the identifying of the relationship may include recognizing the relationship. Further, the method 800 may include determining, using the processing device, at least one conditional statement of the at least one rule using the classification data and the at least one machine learning model. Further, the method 800 may include storing, using the storage device, the classification data and the at least one market practice information.

Further, in some embodiments, the receiving of the server information may include receiving the server information in real time.

Further, in an embodiment, the method 800 may include initializing, using the processing device, at least one sensor based on the at least one client data. Further, the method 800 may include recognizing, using the at least one sensor, at least one element of the server information of a plurality of information associated with the server based on the initializing. Further, the receiving of the server information may be based on the recognizing. Further, the at least one sensor may include a performance monitoring sensor, a resource utilization sensor, a regulation compliance sensor, an environmental sensor, etc. Further, the performance sensor may be configured for monitoring real-time metrics (processing speed, latency, network bandwidth, etc.) of the server and recognizing data associated with the real-time metrics. Further, the resource utilization sensor may be configured for measuring a utilization of resources by the server and recognizing data associated with the utilization of the resources. Further, the regulation compliance sensor may be configured for monitoring a compliance of the server with legal requirements, standards, etc. of the at least one project and recognizing data associated with the compliance of the server.

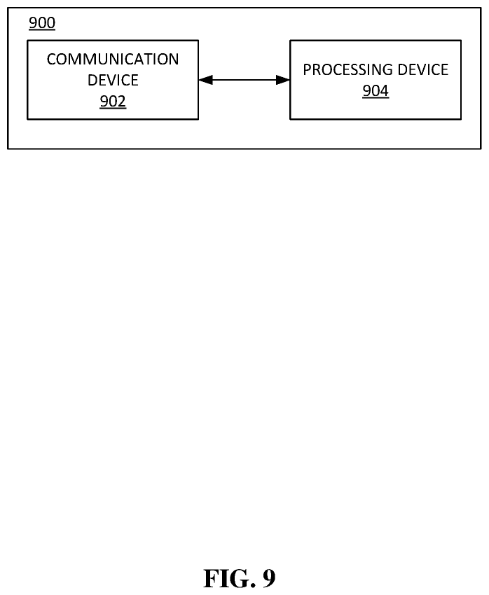

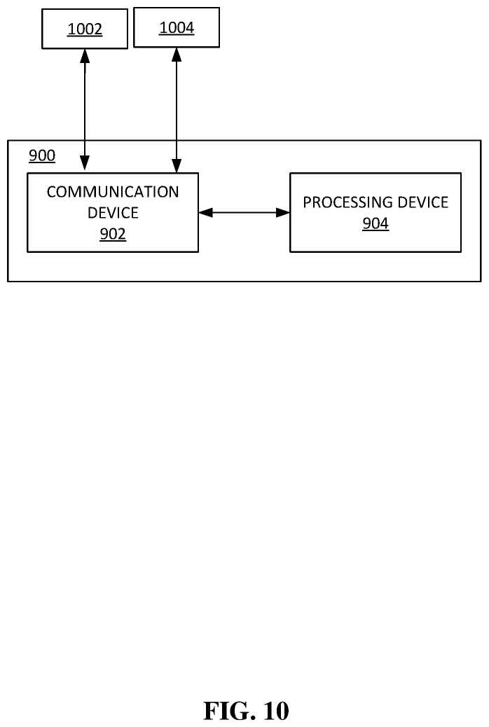

FIG. 9 is a block diagram of a system 900 of facilitating an exit procedure of a project from a cloud service provider, in accordance with some embodiments. Accordingly, the system 900 may include a communication device 902 configured for receiving at least one client data from at least one client device 1002 (as shown in FIG. 10) associated with a client. Further, the at least one client data may include a client credential associated with the client and at least one project data associated with at least one project. Further, the client credential may be used to access at least one cloud service provided by a cloud service provider. Further, the communication device 902 may be configured for transmitting an access request to a server 1004 (as shown in FIG. 10) associated with a cloud service provider. Further, the access request may be based on the client credential. Further, the communication device 902 may be configured for receiving a confirmation corresponding to the access request from the server 1004. Further, the communication device 902 may be configured for transmitting a data request to the server 1004. Further, the communication device 902 may be configured for receiving a server information from the server 1004 based on the data request. Further, the server information may include a plurality of resource information associated with a plurality of resources comprised in the server 1004. Further, the plurality of resource information characterizes the plurality of resources. Further, the communication device 902 may be configured for transmitting at least one of an exit strategy and an exit plan to the at least one client device 1002.

Further, the system 900 may include a processing device 904 communicatively coupled with the communication device 902. Further, the processing device 904 may be configured for generating the data request based on the confirmation. Further, the processing device 904 may be configured for analyzing the server information and the at least one project data. Further, the processing device 904 may be configured for identifying at least one project resource from the plurality of resources associated with the at least one project based on the analyzing of the server information and the at least one project data. Further, the at least one project resource may be configured for implementing the at least one project. Further, the processing device 904 may be configured for analyzing at least one project resource information associated with the at least one project resource based on at least one assessment rule. Further, the server information may include the at least one project resource information. Further, the processing device 904 may be configured for determining at least one risk score corresponding to the at least one project resource based on the analyzing of the at least one project resource information. Further, the at least one risk score represents a severity of a risk associated with the at least one project resource. Further, the processing device 904 may be configured for analyzing the at least one risk score. Further, the processing device 904 may be configured for generating at least one of the exit strategy and the exit plan based on the analyzing of the at least one risk score.

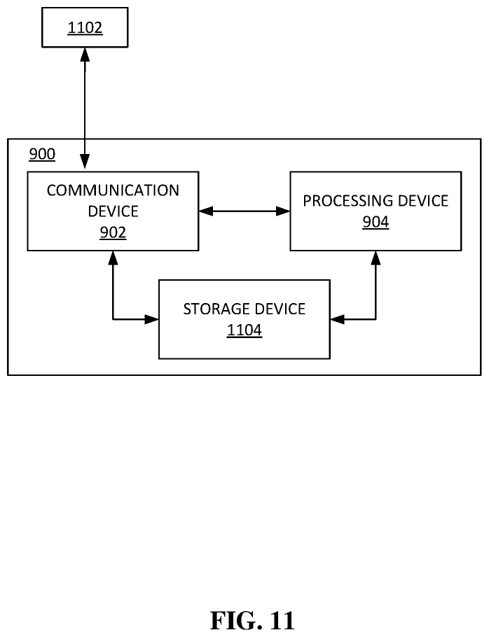

Further, in some embodiments, the communication device 902 may be configured for transmitting one or more destination platform information to the at least one client device 1002. Further, the communication device 902 may be configured for receiving a destination platform indication corresponding to one or more destination platforms from the at least one client device 1002. Further, the destination platform indication may be associated with the destination platform. Further, the communication device 902 may be configured for transmitting the at least one project data to a destination server 1102 (as shown in FIG. 11) associated with the destination platform based on the destination platform indication. Further, the processing device 904 may be configured for obtaining the one or more destination platform information associated with the one or more destination platforms based on at least one of the exit strategy and the exit plan.

Further, in some embodiments, the processing device 904 may be configured for identifying at least one high risk resource from the at least one project resource based on the analyzing of the at least one risk score. Further, the at least one high risk resource may be characterized by a high risk score. Further, the processing device 904 may be configured for obtaining at least one alternative resource information associated with at least one alternative resource for the at least one high risk resource. Further, the communication device 902 may be configured for transmitting the at least one alternative resource information to the at least one client device 1002.

Further, in some embodiments, the at least one project may include at least one financial project associated with a financial sector in a region. Further, the communication device 902 may be configured for receiving a financial data associated with the at least one project from the at least one client device 1002. Further, the financial data corresponds to the region. Further, the processing device 904 may be configured for analyzing the financial data and the at least one project resource information. Further, the processing device 904 may be configured for generating a resource layer value corresponding to each of the at least one project resource based on the analyzing of the financial data and the at least one project resource information. Further, the processing device 904 may be configured for determining at least one project layer value associated with the at least one project based on the resource layer value. Further, the generating of at least one of the exit strategy and the exit plan may be based on the at least one project layer value.

Further, in some embodiments, the processing device 904 may be configured for analyzing at least one of the exit strategy and the exit plan based on a rating grid associated with a regional banking federation in the region. Further, the processing device 904 may be configured for generating at least one graphical representation based on the analyzing of at least one of the exit strategy and the exit plan. Further, the at least one graphical representation represents the at least one project value. Further, the communication device 902 may be configured for transmitting the at least one graphical representation to the at least one client device 1002.

Further, in some embodiments, the processing device 904 may be configured for analyzing at least one of the exit strategy and the exit plan based on an escape rating grid. Further, the processing device 904 may be configured for generating at least one graphical representation based on the analyzing of at least one of the exit strategy and the exit plan. Further, the at least one graphical representation represents the at least one project value. Further, the communication device 902 may be configured for transmitting the at least one graphical representation to the at least one client device 1002.

Further, in some embodiments, the at least one project data may include a sync interval data for scheduling the assessment of the cloud platform. Further, the transmitting of the data request may be based on the sync interval data.

Further, in some embodiments, the at least one project data may include an exit strategy value for performing a risk assessment of the at least one project resource. Further, the analyzing of the at least one project resource information may be based on the exit strategy value.

Further, in some embodiments, the communication device 902 may be configured for receiving at least one feedback associated with at least one of the exit strategy and the exit plan from the at least one client device 1002. Further, the processing device 904 may be configured for tuning the at least one assessment rule based on the at least one feedback. Further, the processing device 904 may be configured for generating at least one tuned assessment rule based on the tuning. Further, the analyzing of the at least one project resource information may be based on the at least one tuned assessment rule.

Further, in some embodiments, the processing device 904 may be configured for obtaining at least one market practice information associated with the at least one assessment rule. Further, the at least one market practice information represents one or more characteristics of at least one cloud service provided by at least one second cloud service provider. Further, the processing device 904 may be configured for tuning the at least one assessment rule based on the at least one market practice information. Further, the processing device 904 may be configured for generating at least one tuned assessment rule based on the tuning. Further, the analyzing of the at least one project resource information may be based on the at least one tuned assessment rule.

FIG. 10 is a block diagram of the system 900 of facilitating the exit procedure of the project from the cloud service provider, in accordance with some embodiments.

FIG. 11 is a block diagram of the system 900 of facilitating the exit procedure of the project from the cloud service provider, in accordance with some embodiments. Further, the system 900 may include a storage device 1104 communicatively coupled with the communication device 902 and the processing device 904.

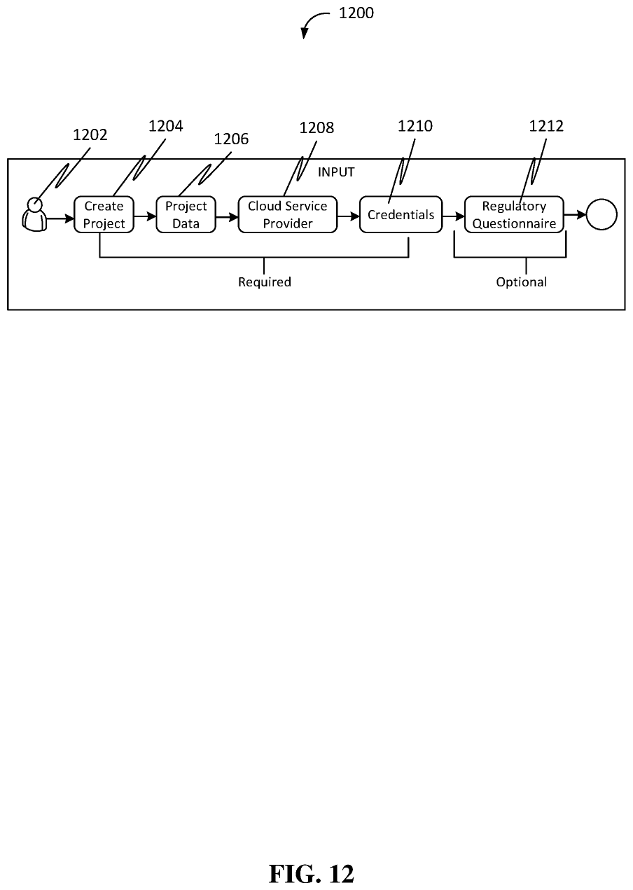

FIG. 12 is a flow chart of a method 1200 of facilitating an exit procedure of a project from a cloud service provider, in accordance with some embodiments. Accordingly, the method 1200 may include receiving inputs from a client device associated with a client 1202. Further, at 1204, the method 1200 may include creating a project based on including a project data 1206. Further, at 1208, the method 1200 may include selecting a cloud service provider. Further, at 1210, the method 1200 may include setting credentials by the client 1202. Further, optionally, at 1212, the method 1200 may include a receiving input corresponding to a regulatory questionnaire to assess the project in terms of a European banking federation's rating grid.

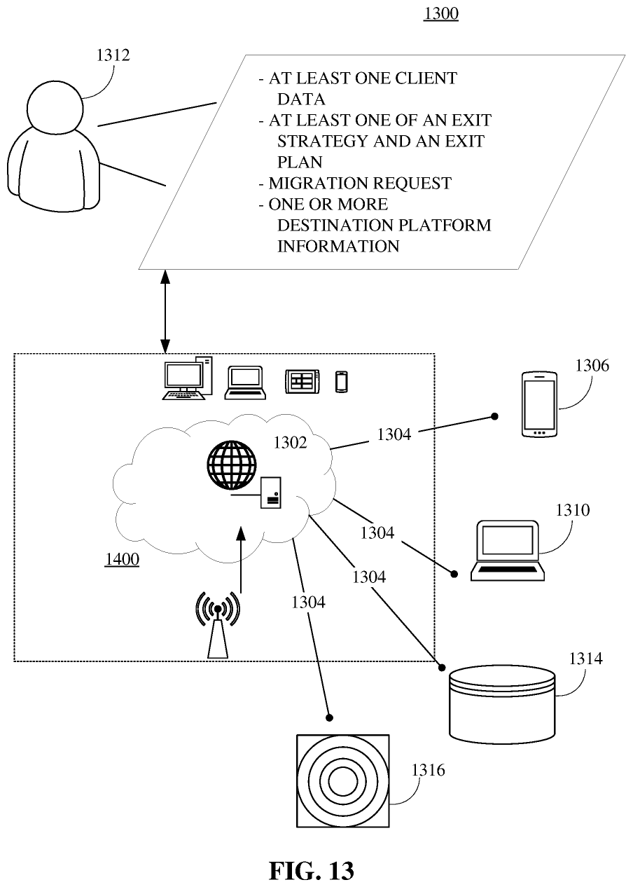

FIG. 13 is an illustration of an online platform 1300 consistent with various embodiments of the present disclosure. By way of non-limiting example, the online platform 1300 to facilitate an exit procedure of a project from a cloud service provider may be hosted on a centralized server 1302, such as, for example, a cloud computing service. The centralized server 1302 may communicate with other network entities, such as, for example, a mobile device 1306 (such as a smartphone, a laptop, a tablet computer, etc.), other electronic devices 1310 (such as desktop computers, server computers, etc.), databases 1314, and sensors 1316 over a communication network 1304, such as, but not limited to, the Internet. Further, users of the online platform 1300 may include relevant parties such as, but not limited to, end-users, administrators, service providers, service consumers, and so on. Accordingly, in some instances, electronic devices operated by the one or more relevant parties may be in communication with the platform.

A user 1312, such as the one or more relevant parties, may access online platform 1300 through a web based software application or browser. The web based software application may be embodied as, for example, but not be limited to, a website, a web application, a desktop application, and a mobile application compatible with a computing device 1400.

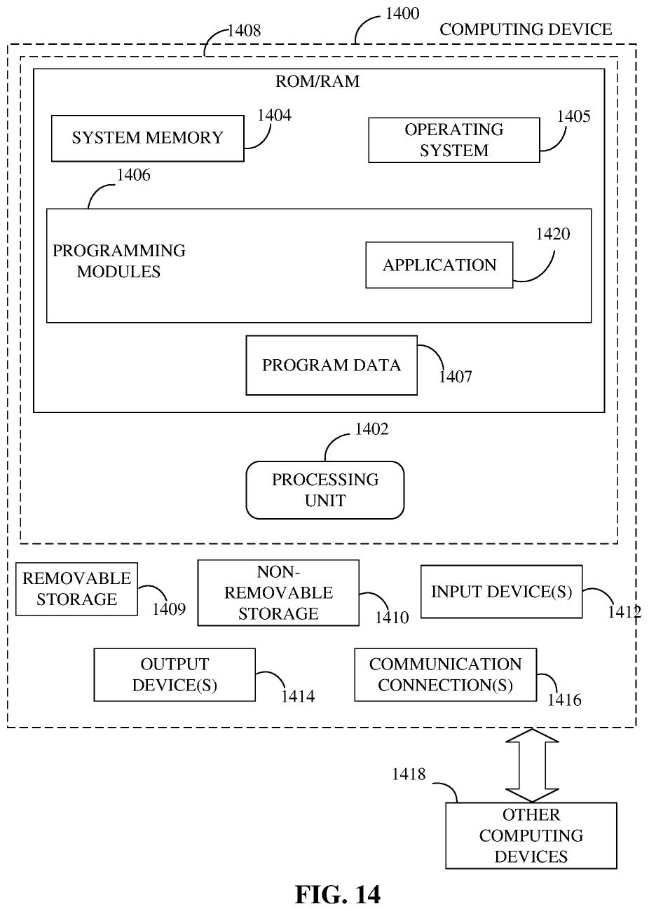

With reference to FIG. 14, a system consistent with an embodiment of the disclosure may include a computing device or cloud service, such as computing device 1400. In a basic configuration, computing device 1400 may include at least one processing unit 1402 and a system memory 1404. Depending on the configuration and type of computing device, system memory 1404 may comprise, but is not limited to, volatile (e.g. random-access memory (RAM)), non-volatile (e.g. read-only memory (ROM)), flash memory, or any combination. System memory 1404 may include operating system 1405, one or more programming modules 1406, and may include a program data 1407. Operating system 1405, for example, may be suitable for controlling computing device 1400's operation. In one embodiment, programming modules 1406 may include image-processing module, machine learning module. Furthermore, embodiments of the disclosure may be practiced in conjunction with a graphics library, other operating systems, or any other application program and is not limited to any particular application or system. This basic configuration is illustrated in FIG. 14 by those components within a dashed line 1408.

Computing device 1400 may have additional features or functionality. For example, computing device 1400 may also include additional data storage devices (removable and/or non-removable) such as, for example, magnetic disks, optical disks, or tape. Such additional storage is illustrated in FIG. 14 by a removable storage 1409 and a non-removable storage 1410. Computer storage media may include volatile and non-volatile, removable, and non-removable media implemented in any method or technology for storage of information, such as computer-readable instructions, data structures, program modules, or other data. System memory 1404, removable storage 1409, and non-removable storage 1410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD), or other optical storage, magnetic cassettes, magnetic tape, magnetic disk storage or other magnetic storage devices, or any other medium which can be used to store information and which can be accessed by computing device 1400. Any such computer storage media may be part of device 1400. Computing device 1400 may also have input device(s) 1412 such as a keyboard, a mouse, a pen, a sound input device, a touch input device, a location sensor, a camera, a biometric sensor, etc. Output device(s) 1414 such as a display, speakers, a printer, etc. may also be included. The aforementioned devices are examples and others may be used.

Computing device 1400 may also contain a communication connection 1416 that may allow device 1400 to communicate with other computing devices 1418, such as over a network in a distributed computing environment, for example, an intranet or the Internet. Communication connection 1416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1404, including operating system 1405. While executing on processing unit 1402, programming modules 1406 (e.g., application 1420 such as a media player) may perform processes including, for example, one or more stages of methods, algorithms, systems, applications, servers, databases as described above. The aforementioned process is an example, and processing unit 1402 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method of facilitating an exit procedure of a project from a cloud service provider, the method comprising:
receiving, using a communication device, at least one client data from at least one client device associated with a client, wherein the at least one client data comprises a client credential associated with the client and at least one project data associated with at least one project;
transmitting, using the communication device, an access request to a server associated with a cloud service provider, wherein the access request is based on the client credential;
receiving, using the communication device, a confirmation corresponding to the access request from the server;
generating, using a processing device, a data request based on the confirmation;
transmitting, using the communication device, the data request to the server;
receiving, using the communication device, a server information from the server based on the data request, wherein the server information comprises a plurality of resource information associated with a plurality of resources comprised in the server, wherein the plurality of resource information characterizes the plurality of resources;
analyzing, using the processing device, the server information and the at least one project data;
identifying, using the processing device, at least one project resource from the plurality of resources associated with the at least one project based on the analyzing of the server information and the at least one project data, wherein the at least one project resource is configured for implementing the at least one project;
analyzing, using the processing device, at least one project resource information associated with the at least one project resource based on at least one assessment rule, wherein the server information comprises the at least one project resource information;
determining, using the processing device, at least one risk score corresponding to the at least one project resource based on the analyzing of the at least one project resource information, wherein the at least one risk score represents a severity of a risk associated with the at least one project resource;
analyzing, using the processing device, the at least one risk score;
generating, using the processing device, at least one of an exit strategy and an exit plan based on the analyzing of the at least one risk score; and
transmitting, using the communication device, at least one of the exit strategy and the exit plan to the at least one client device.

2. The method of claim 1 further comprising:
obtaining, using the processing device, one or more destination platform information associated with one or more destination platforms based on at least one of the exit strategy and the exit plan;
transmitting, using the communication device, the one or more destination platform information to the at least one client device;
receiving, using the communication device, a destination platform indication corresponding to the one or more destination platforms from the at least one client device, wherein the destination platform indication is associated with the destination platform; and
transmitting, using the communication device, the at least one project data to a destination server associated with the destination platform based on the destination platform indication.

3. The method of claim 1 further comprising:
identifying, using the processing device, at least one high risk resource from the at least one project resource based on the analyzing of the at least one risk score, wherein the at least one high risk resource is characterized by a high risk score;
obtaining, using the processing device, at least one alternative resource information associated with at least one alternative resource for the at least one high risk resource; and
transmitting, using the communication device, the at least one alternative resource information to the at least one client device.

4. The method of claim 1, wherein the at least one project comprises at least one financial project associated with a financial sector in a region, wherein the method further comprises:
receiving, using the communication device, a financial data associated with the at least one project from the at least one client device, wherein the financial data corresponds to the region;
analyzing, using the processing device, the financial data and the at least one project resource information;
generating, using the processing device, a resource layer value corresponding to each of the at least one project resource based on the analyzing of the financial data and the at least one project resource information; and
determining, using the processing device, at least one project layer value associated with the at least one project based on the resource layer value, wherein the generating of at least one of the exit strategy and the exit plan is further based on the at least one project layer value.

5. The method of claim 4 further comprising:
analyzing, using the processing device, at least one of the exit strategy and the exit plan based on a rating grid associated with a regional banking federation in the region;
generating, using the processing device, at least one graphical representation based on the analyzing of at least one of the exit strategy and the exit plan, wherein the at least one graphical representation represents the at least one project value; and
transmitting, using the communication device, the at least one graphical representation to the at least one client device.

6. The method of claim 4 further comprising:
analyzing, using the processing device, at least one of the exit strategy and the exit plan based on an escape rating grid;
generating, using the processing device, at least one graphical representation based on the analyzing of at least one of the exit strategy and the exit plan, wherein the at least one graphical representation represents the at least one project value; and
transmitting, using the communication device, the at least one graphical representation to the at least one client device.

7. The method of claim 1, wherein the at least one project data comprises a sync interval data for scheduling the assessment of the cloud platform, wherein the transmitting of the data request is further based on the sync interval data.

8. The method of claim 1, wherein the at least one project data comprises an exit strategy value for performing a risk assessment of the at least one project resource, wherein the analyzing of the at least one project resource information is further based on the exit strategy value.

9. The method of claim 1 further comprising:
receiving, using the communication device, at least one feedback associated with at least one of the exit strategy and the exit plan from the at least one client device;
tuning, using the processing device, the at least one assessment rule based on the at least one feedback; and
generating, using the processing device, at least one tuned assessment rule based on the tuning, wherein the analyzing of the at least one project resource information is further based on the at least one tuned assessment rule.

10. The method of claim 1 further comprising:
obtaining, using the processing device, at least one market practice information associated with the at least one assessment rule, wherein the at least one market practice information represents one or more characteristics of at least one cloud service provided by at least one second cloud service provider;
tuning, using the processing device, the at least one assessment rule based on the at least one market practice information; and
generating, using the processing device, at least one tuned assessment rule based on the tuning, wherein the analyzing of the at least one project resource information is further based on the at least one tuned assessment rule.

11. A system of facilitating an exit procedure of a project from a cloud service provider, the system comprising:
a communication device configured for:
receiving at least one client data from at least one client device associated with a client, wherein the at least one client data comprises a client credential associated with the client and at least one project data associated with at least one project;
transmitting an access request to a server associated with a cloud service provider, wherein the access request is based on the client credential;
receiving a confirmation corresponding to the access request from the server;
transmitting a data request to the server;
receiving a server information from the server based on the data request, wherein the server information comprises a plurality of resource information associated with a plurality of resources comprised in the server, wherein the plurality of resource information characterizes the plurality of resources; and
transmitting at least one of an exit strategy and an exit plan to the at least one client device; and
a processing device communicatively coupled with the communication device, wherein the processing device is configured for:
generating the data request based on the confirmation;
analyzing the server information and the at least one project data;
identifying at least one project resource from the plurality of resources associated with the at least one project based on the analyzing of the server information and the at least one project data, wherein the at least one project resource is configured for implementing the at least one project;
analyzing at least one project resource information associated with the at least one project resource based on at least one assessment rule, wherein the server information comprises the at least one project resource information;
determining at least one risk score corresponding to the at least one project resource based on the analyzing of the at least one project resource information, wherein the at least one risk score represents a severity of a risk associated with the at least one project resource;
analyzing the at least one risk score; and
generating at least one of the exit strategy and the exit plan based on the analyzing of the at least one risk score.

12. The system of claim 11, wherein the communication device is further configured for:
transmitting one or more destination platform information to the at least one client device;
receiving a destination platform indication corresponding to one or more destination platforms from the at least one client device, wherein the destination platform indication is associated with the destination platform; and
transmitting the at least one project data to a destination server associated with the destination platform based on the destination platform indication, wherein the processing device is further configured for obtaining the one or more destination platform information associated with the one or more destination platforms based on at least one of the exit strategy and the exit plan.

13. The system of claim 11, wherein the processing device is further configured for:
identifying at least one high risk resource from the at least one project resource based on the analyzing of the at least one risk score, wherein the at least one high risk resource is characterized by a high risk score; and
obtaining at least one alternative resource information associated with at least one alternative resource for the at least one high risk resource, wherein the communication device is further configured for transmitting the at least one alternative resource information to the at least one client device.

14. The system of claim 11, wherein the at least one project comprises at least one financial project associated with a financial sector in a region, wherein the communication device is further configured for receiving a financial data associated with the at least one project from the at least one client device, wherein the financial data corresponds to the region, wherein the processing device is further configured for:
analyzing the financial data and the at least one project resource information;
generating a resource layer value corresponding to each of the at least one project resource based on the analyzing of the financial data and the at least one project resource information; and
determining at least one project layer value associated with the at least one project based on the resource layer value, wherein the generating of at least one of the exit strategy and the exit plan is further based on the at least one project layer value.

15. The system of claim 14, wherein the processing device is further configured for:
analyzing at least one of the exit strategy and the exit plan based on a rating grid associated with a regional banking federation in the region; and
generating at least one graphical representation based on the analyzing of at least one of the exit strategy and the exit plan, wherein the at least one graphical representation represents the at least one project value, wherein the communication device is further configured for transmitting the at least one graphical representation to the at least one client device.

16. The system of claim 14, wherein the processing device is further configured for:
analyzing at least one of the exit strategy and the exit plan based on an escape rating grid; and
generating at least one graphical representation based on the analyzing of at least one of the exit strategy and the exit plan, wherein the at least one graphical representation represents the at least one project value, wherein the communication device is further configured for transmitting the at least one graphical representation to the at least one client device.

17. The system of claim 11, wherein the at least one project data comprises a sync interval data for scheduling the assessment of the cloud platform, wherein the transmitting of the data request is further based on the sync interval data.

18. The system of claim 11, wherein the at least one project data comprises an exit strategy value for performing a risk assessment of the at least one project resource, wherein the analyzing of the at least one project resource information is further based on the exit strategy value.

19. The system of claim 11, wherein the communication device is further configured for receiving at least one feedback associated with at least one of the exit strategy and the exit plan from the at least one client device, wherein the processing device is further configured for:
tuning the at least one assessment rule based on the at least one feedback; and
generating at least one tuned assessment rule based on the tuning, wherein the analyzing of the at least one project resource information is further based on the at least one tuned assessment rule.

20. The system of claim 11, wherein the processing device is further configured for:
obtaining at least one market practice information associated with the at least one assessment rule, wherein the at least one market practice information represents one or more characteristics of at least one cloud service provided by at least one second cloud service provider;
tuning the at least one assessment rule based on the at least one market practice information; and
generating at least one tuned assessment rule based on the tuning, wherein the analyzing of the at least one project resource information is further based on the at least one tuned assessment rule.
